(19) United States
(12) Patent Application Publication
(10) Pub. No.: US 2008/0116127 A1
(43) Pub. Date: May 22, 2008

(54) SUMP AND FILTER ASSEMBLY

(75) Inventors: Carey A. Curt, Cookeville, TN (US); Gregory D. Shope, Cookeville, TN (US)

Correspondence Address: HAMRE, SCHUMANN, MUELLER & LARSON, P.C., P.O. BOX 2902, MINNEAPOLIS, MN, 55402-0902, US

(73) Assignee: CUMMINS FILTRATION IP, INC., Minneapolis, MN (US)

(21) Appl. No.: 11/562,265

(22) Filed: Nov. 21, 2006

(51) Int. Cl. B01D 35/027; F01M 9/00

(52) U.S. Cl. 210/172.2; 123/196 R

(57) ABSTRACT

A sump and filter assembly is provided that includes a sump component and a filter component operatively connected with the sump component. The sump component has an inlet receivable of fluid and a capacity for fluid. The filter component is configured to filter fluid from the sump component and has an outlet enabling release of fluid from the assembly. The sump and filter components define a fluid pathway between the inlet and outlet. The fluid pathway enables fluid entering the inlet to flow from the sump component and through the filter component to the outlet. The sump and filter combination provides an assembly that would contain most of the oil capacity function together with the filtration function in one package. As a result, a lubrication filtration system may be quickly serviced in a cleaner environment.

### FIELD

A sump and filter assembly for internal combustion engines, including gasoline and diesel engines such as those in automobiles, trucks, heavy equipment, and the like, which require fluid filtration, such as lubrication oil filtration. A sump and filter assembly is provided that is particularly helpful, as one example, in servicing engine lubrication systems for on-the-road (OTR) trucks.

### BACKGROUND

Internal combustion engines are still the predominant means for propelling motorized vehicles. They are proven to offer many advantages over alternative mechanisms, among these being cost and convenience. Such engines require lubrication, usually employing a circulating lubricant such as oil. Filter assemblies are commonly used to filter the oil to remove contaminants, thereby protecting the engine and preventing damage to the engine and its components lubricated by the oil.

In OTR trucks, for instance, lubrication oil from the engine collects in an oil pan, and is then pumped and filtered to circulate back through the engine. Typically in such engine configurations, the majority of the oil capacity resides in the oil pan or sump toward the bottom of the engine. Further, the filtration system commonly includes filter elements housed in an exterior housing (typically called “spin-on” filter assemblies). These filter elements are found either on the engine or mounted beside the engine. The oil pan and filter elements in these engine configurations reside within a truck's frame rails and under the truck hood.

However, servicing lubrication filtration systems, in for example OTR trucks, is a dirty task. Removing the filters is a challenge because of space constraints on current truck engine designs. Draining and changing the oil is also messy and the filters can be hard to handle. As a result of these design shortcomings, the environment for servicing lubrication oil systems is not ideal. Thus, there is a need to provide an improved service option and environment for servicing filtration lubrication systems.

### SUMMARY

A sump and filter assembly is provided that includes a sump component and filter element component combination. The sump has an inlet receivable for fluid and a capacity for fluid. The capacity of the sump is configured to allow collection of fluid therein and fluid flow therethrough when the assembly is in use, and to allow storage of fluid when the assembly is not in use. The filter element is connected to the sump. Preferably, the filter element is disposed inside the sump. The filter element is configured to filter fluid from the sump and has an outlet to release fluid from the assembly. The assembly defines a fluid pathway enabling fluid to enter the inlet, to flow from the sump and to the filter element, and to be released through the outlet. The sump and filter element combination provides an assembly for a lubrication filtration system that would combine the lube capacity component together with the filtration component in one package. As a result, a lubrication filtration system may be quickly serviced in a cleaner environment.

The sump and filter element combination can provide a single prepackaged lubrication service product. The prepackaged product would include the sump or container, the filter element, and fresh engine oil. When an old sump and filter assembly needs changing, the used assembly would be disconnected, as one unit, from inlet and outlet supply lines to and from the used assembly, and a new assembly would be connected, as one unit, in replacement of the old assembly.

In one embodiment, a sump and filter assembly is provided that comprises a sump having a capacity for fluid and a filter element disposed inside the sump. The filter element is configured to filter fluid from the sump. The sump and filter element define an inlet, an outlet, and a fluid pathway between the inlet and outlet. The inlet is disposed at the sump and receivable of fluid. The outlet is disposed at the filter element and enables release of fluid. The fluid pathway enables fluid entering the inlet to flow from the sump, to the filter element, and through the outlet.

In another embodiment, a lubrication filter assembly for a vehicle is provided that comprises a sump having a capacity for lubrication oil and a filter element disposed inside the sump. The filter element is configured to filter lubrication oil from the sump. The sump and filter element define an inlet, an outlet, and a lubrication oil pathway between the inlet and outlet. The inlet is disposed at the sump and receivable of lubrication oil. The outlet is disposed at the filter element and enables release of lubrication oil. The fluid pathway enables lubrication oil entering the inlet to flow from the sump, to the filter element, and through the outlet.

In yet another embodiment, a kit for servicing an engine lubrication system of an internal combustion engine comprises the lubrication filter assembly contained in a packaging structure.

In another embodiment, a method for servicing an engine lubrication system of an internal combustion engine is provided. The method comprises disconnecting a used lubrication filter assembly from inlet and outlet supply lines. The lubrication filter assembly is removed by removing both the sump and filter element as one unit. A new lubrication filter assembly is then introduced by connecting the sump and filter element of the new lubrication filter assembly as one unit to the inlet and outlet supply lines.

### BRIEF DESCRIPTION OF THE DRAWINGS

FIG. 1 illustrates a schematic view of one embodiment of a sump and filter assembly incorporating the inventive concepts.

FIG. 2 illustrates a schematic view of the sump and filter assembly of FIG. 1, while showing one embodiment of an application of the same and incorporating the inventive concepts.

FIG. 3 illustrates a schematic view of another embodiment of a sump and filter assembly incorporating the inventive concepts.

FIG. 4 illustrates an external view of another embodiment of a sump and filter assembly incorporating the inventive concepts.

FIG. 5 illustrates a schematic for a kit for servicing an engine lubrication system of an internal combustion engine incorporating the inventive concepts.

### DETAILED DESCRIPTION

Generally, a sump and filter assembly is described that includes a sump component combined with a filter component. The sump has an inlet receivable for fluid and a capacity for fluid. The capacity of the sump is configured to allow collection of fluid therein and fluid flow therethrough when the assembly is in use, and to allow storage of fluid when the assembly is not in use. The filter component is connected to the sump. The filter component is configured to filter fluid from the sump and has an outlet to release fluid from the assembly. The assembly defines a fluid pathway enabling fluid to enter the inlet, to flow from the sump and to the filter component, and to be released through the outlet.

In general, the assemblies herein described may be useful for combining a storage component with a filtering component, so as to provide an auxiliary sump and filter combination that can be remotely disposed from engine or equipment components. As one example only, the sump and filter element combination provides an assembly for a lubrication filtration system in an engine that would combine the lube capacity component together with the filtration component in one package. As a result, a lubrication filtration system may be quickly serviced in a cleaner environment.

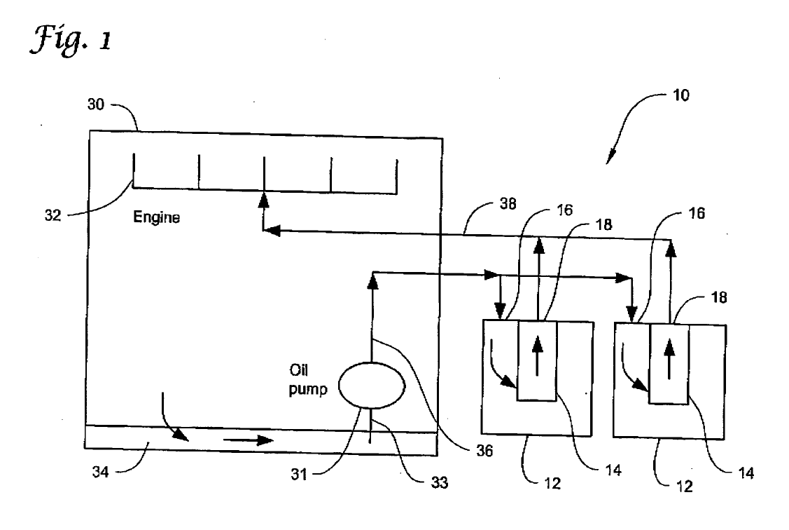

FIG. 1 is a schematic illustration of one embodiment of a sump and filter assembly 10. The assembly 10 includes a sump 12 and a filter element 14 disposed inside the sump 12. The filter element 14 is configured to filter fluid from the sump 12. The sump 12 and filter element 14 define an inlet 16, an outlet 18, and a fluid pathway between the inlet and outlet. The fluid pathway is indicated by the directional arrows within each sump 12 and filter element 14 combination. The fluid pathway enables fluid entering the inlet 16 to flow from the sump 12, to the filter element 14, and through the filter element 14 to the outlet 18.

The inlet 16 is disposed at the sump 12 and is receivable of fluid. The outlet is disposed at the filter element 14 and enables release of fluid. As in FIG. 1, the assembly 10 may be a part of an engine oil lubrication system, such as for example an engine 30. The assembly 10 is disposed, for example, on a pathway of the engine oil lubrication system where the sump 12 and filter element 14 reside between an oil pump 31 and the engine 30. Engine oil in use will pass through oil passages 32 of the engine 30, and collect in an oil pan 34 (or shallow sump) toward the bottom of the engine 30. The oil pump 31 pumps engine oil from the oil pan 34 through supply line 33 and delivers the engine oil to the assembly 10 through supply line 36. Once the engine oil is delivered to the inlet 16, the engine oil may flow (as indicated by directional arrows) into and through the sump 12 and then through the filter element 14. That is, oil is collected in the oil pan 34 and pumped by the oil pump 31 to the sump 12. The filter element 14 filters the “dirty” oil entering the sump 12. After the engine oil is filtered, it may be released from the assembly 10. That is, the filtered engine oil exits the outlet 18 and is delivered back to the engine 30 through supply line 38.

In the embodiment shown in FIG. 1, the assembly 10 is disposed between the oil pump 31 and engine 30. That is, both the sump 12 and the filter element 14 are disposed on an engine lubrication system pathway, which is indicated by the directional arrows shown, whereby the assembly 10 is located between the supply lines 36 and 38.

The sump 12 is a container or canister structure having a capacity for fluid. The capacity of the sump 12 is configured to allow collection of fluid and fluid flow therethrough when the assembly is in use. The sump 12 also allows storage of fluid when the assembly is not in use. The sump 12 can act as a larger “pit” or reservoir in addition and relative to the oil pan 34 (more shallow). That is, the sump 12 acts as an auxiliary reservoir downstream from the oil pan 34 and oil pump 31 on the engine lubrication system pathway. In such a configuration, the majority of the fluid capacity that typically resides in the engine oil pan is moved to the sump 12 of the assembly 10, so that an oil pan may have a more shallow design.

As one example only, the sump 12 may be a bag or bucket structure or a combination of a bag in a bucket. As one example only, the sump 12 may have a fluid capacity of about 5 gallons, for instance such as a typical 5 gallon bucket. It will be appreciated that the sump 12 may have other volume capacities as suitable for use. In one preferred configuration only, the sump 12 would have a volume capacity for a fluid so as to approximately weigh 45-50 lbs, so that a service person can still service and/or change the assembly. It will be appreciated, however, that smaller and larger capacities for the sump 12 may be employed as suitable and necessary.

By the term “fluids,” it generally is meant to be a material requiring filtration. The fluids may be any material typically used with automotive internal combustion engines, such as but not limited to engine oils, coolants, fuel, hydraulic fluids, and other various working fluids.

It will be appreciated that the filter element 14 is operatively connected with the sump 12, so that fluid may filter through the sump and filter assembly. The term operatively connected is not limited to any specific structure, so long as the filter element and sump are arranged and configured to enable fluid to flow through the assembly. Preferably the filter element is attached, connected, or mounted inside the sump 12, and filters fluid from the sump 12 and through the outlet 18. It will be appreciated that the manner in which the filter element is disposed inside the sump 12 is not limited to a specific structure. With the filter element disposed inside the sump 12, economy of space can be achieved.

It further will be appreciated, however, that the filter element may not be disposed inside the sump. That is, the filter element may include its own inlet to be attached externally to an outlet of the sump.

As shown, the filter element 14 is disposed inside the sump 12 and toward one end of the sump 12, so that the outlet 18 can suitably access and release the fluid filtered by the filter element 14. As shown in FIG. 1, one exemplary position for the filter element is at the top side of the sump 12. The filter element 14 may be any filter element, both known and novel, that is suitable for combination with the sump 12. The filter element is not limited to any particular structure, so long as it may be disposed inside the sump 12 and capable for filtering fluid from the sump 12 and out of the outlet 18. As some examples only, the filter element may be capable of full flow filtering or bypass filtering. The filter element, for example, may be a cartridge or a plurality of cartridges having various filter media configurations.

FIG. 1 shows the assembly 10 having two sump and filter element combinations shown in parallel. However, it will be appreciated that a single sump and filter element combination may be sufficient. It will be further appreciated that more than two sump and filter combinations may be employed. The number and arrangement of sump and filter combinations is not limited, so long as the engine size and needs are being met to provide a desired filtering and engine performance.

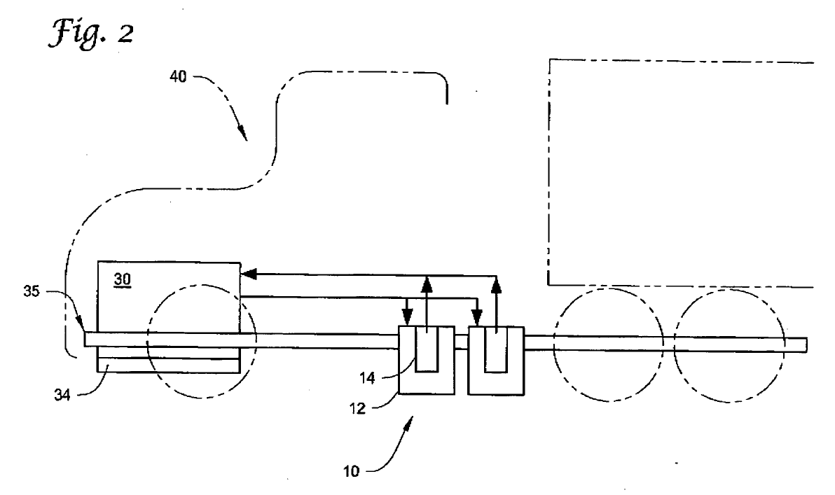

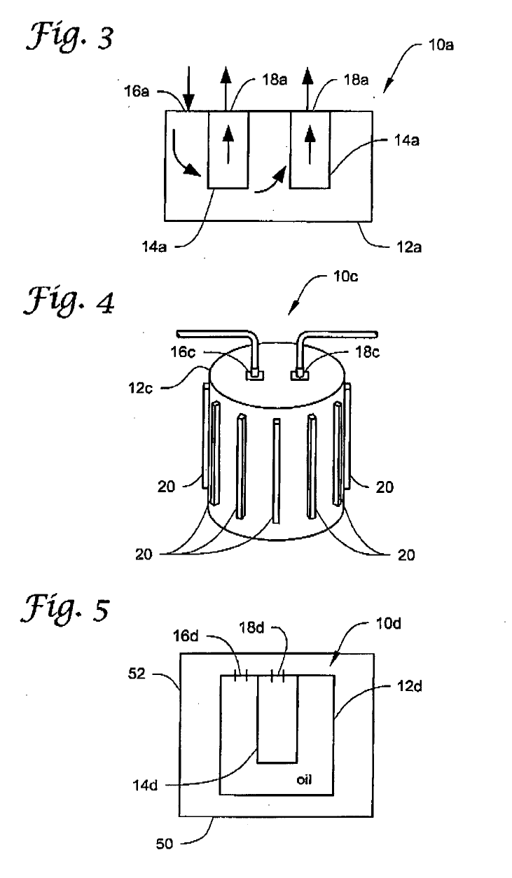

Moreover, it will be appreciated that a sump and filter element combination does not require a sump for every filter element, such as in a one to one combination. For example, FIG. 3 illustrates another embodiment for a sump and filter element combination in sump and filter assembly 10a. As shown, the assembly 10a includes a plurality of filter elements 14a disposed inside a single sump 12a. As with FIG. 1, the sump would include an inlet 16a, however, each filter element would include its own outlet 18a. Fluid flow through the sump 12a and filter elements 14a is indicated by the directional arrows. Fluid flow is similar to the flow as in FIGS. 1 and 2, except that more than one filter element 14a is provided to filter the fluid from the sump 12a and out to a supply line. As shown, two filter elements 14a are shown in the sump 12a. However, it will be appreciated that more than two filter elements 14a may be employed within a sump 12a, and as necessary or desired to provide a desired filtering and engine performance.

FIG. 2 illustrates the sump and filter assembly 10 shown in FIG. 1, while further showing one non-limiting example of its application, such as for use in an OTR truck 40. As shown, the filter assembly 10 (including the sump 12 and filter element 14) is disposed remotely from the engine 30 and oil pan 34 (shallow). In one preferred example only, the assembly 10 may be disposed externally, such as outside a frame rail 35. That is, the assembly 10 resides outside a frame rail 35 that surrounds the engine 30. In typical engine configurations, the entire lubrication filtration system resides within the space designed by the frame rail structure and usually under the hood. However, in the configuration shown in FIG. 2, the sump 12 and filter element 14 combination may be disposed more remotely from where the engine 30 and oil pan 34 reside. The assembly 10 can allow improved flexibility of placement for the sump 12 and filter element 14 combination(s).

It will be appreciated that FIG. 2 represents an exemplary position for the assembly 10 only. It will be further appreciated that placement of the assembly 10 is not limited to being outside the frame rail 35, so long as the assembly 10 can be disposed remotely while providing effective filtration and facilitating engine performance. As some other examples only, the assembly 10 may also be disposed from the top side of the vehicle, such as towards an engine hood of an OTR truck, or disposed on a bumper, or on any rigid component of a vehicle and in any suitable position, so that the assembly can be remotely disposed from where an engine is contained. It further will be appreciated that the assembly 10 is not limited to use in OTR trucks, and may be implemented in a variety of other vehicles and process equipment for which the assembly may be useful.

FIG. 4 illustrates an external view of another embodiment of a sump and filter assembly 10c. The filter element for the assembly 10c is not shown, however, it will be appreciated that a filter element as already described above is suitable for and may be implemented in the assembly 10c. Similarly as the previously described assemblies, assembly 10c includes a sump 12c that defines an inlet 16c to the sump 12c and outlet 18c that would connect with the filter element. In addition, the assembly 10c includes cooling fins 20 that are incorporated on an outer surface of the sump 12c. The cooling fins 20 can, for example, provide a cooling effect on engine oil in the lubrication filtration system, which is not otherwise enjoyed in typical engine designs. This is because the inventive sump and filter element combination can be disposed more remotely and away from an engine. Thus, the cooling fins can provide cooler air to access the oil in the assembly, because the majority of the oil would be outside of the hot engine environment.

As shown, there is a plurality of cooling fins 20. It also will be appreciated that any number of cooling fins 20 or a single cooling fin may be employed as necessary to achieve a desired cooling effect. The cooling fins are shown as extending from end to end about an outer cylindrical surface of the sump 12c. It further will be appreciated that the configuration and arrangement of the cooling fins is not limited, so long as they can provide cooler air to access the inside of the assembly. As some other examples only, the cooling fins may be axially, radially, or spirally arranged and configured.

FIG. 5 illustrates a schematic for a kit 50 for a sump and filter assembly. As with the other assemblies described, an assembly 10d includes a sump 12d and filter element 14d that define an inlet 16d to the sump 12d and outlet 18d from the filter element 14d. The kit 50 includes fresh oil within at least the sump 12d. The assembly 10d may be stored in a separate packaging structure 52. The packaging structure 52 may be any structure and material that can suitably contain and store the assembly 10d during transport and before use.

The material for the packaging structure 52 is not limited, so long as a material is employed to comply with industry safety standards and regulations. As another example, an outer container material of the sump itself may provide the necessary packaging structure. As described above for example, the sump 12 may be a flexible bag or bucket or a combination of a flexible bag in a bucket with the filter attached inside the bag. Such an outer container material may serve as the necessary packaging structure for a kit.

It will be appreciated that the inlet 16d and outlet 18d are sufficiently sealed so that spills do not occur during transport or while in storage, such as before the assembly 10d is to be used. The inlet(s) and outlet(s) may include quick connect/disconnect features to allow easy and convenient connection to the supply lines of the engine lubrication filtration system. It will be appreciated that any of the sump and filter assemblies described may be suitable for packaging in a kit (i.e. kit 50). As one non-limiting example, a kit such as kit 50, may be helpful for servicing an engine lubrication system of an internal combustion engine in OTR trucks.

Any of the sump and filter assemblies described may be replaced with a new assembly (i.e. sump and filter including a fluid packaged therein) after use. A service person, for example, may perform such operation. In this regard, when a used sump and filter assembly is to be changed, the used sump and filter assembly is disconnected at the inlet(s) and outlet(s). The order of disconnection of the inlet(s) and outlet(s) is not limited. It will be appreciated that the inlet(s) and outlet(s) may be simultaneously disconnected at the same time, if desired or necessary, such as for furthering safety precautions with respect to line pressure or for cleanliness issues. Once disconnected, the used sump and filter assembly can be removed as one unit. The new sump and filter assembly can then be connected at the inlet(s) and outlet(s). The order of connection of the inlet(s) and outlet(s) is also not limited. It will be appreciated that the inlet(s) and outlet(s) may also be simultaneously connected if desired or necessary.

The sump and filter assemblies described can offer a number of benefits for engine lubrication filtration systems, such as for OTR trucks. It will be appreciated that the sump and filter assemblies described may also be used in a variety of other lube filtration applications including, but not limited to, lube filtration in automatic transmissions, in offroad mining equipment, in marine equipment, and other processing equipment or the like. The description herein offers an assembly that combines components of both the engine lubrication system and the engine lube filtration system.

Among such benefits, the assemblies described can further provide a “quick service” option for servicing of an engine lubrication filtration system. That is, the sump and filter element combination(s) can be remotely located with respect to the engine, oil pan, and oil pump, which are usually contained within the engine frame rails. As a result, a “one product service” is provided that is easily replaceable as one package or unit. For example, the product may be a bag of oil having a filter attached internally in the bag and then contained in a bucket-like container. This bag in bucket style design may also include removable liners as the bag structure for holding the oil and filter therein.

The combination of oil and filter in one package allows for quick service and a unique lubrication system package. It also allows for a shallower oil pan on the engine. As the majority of the oil capacity typically resides in the engine oil pan, the sump component of the inventive assembly can move a significant portion of the oil capacity to this remote sump component. Advantageously, both the engine manufacturer and the original equipment manufacturer (OEM) truck manufacturers have more options for engine design. The typical oil pan may be reduced to a “minimal sump” that only requires enough capacity to feed the oil pump. With such engine design flexibility, the height of engine confined by the frame rails could be lowered, allowing different truck hood configurations that would only accept an engine design with this minimal profile. That is, the assembly gives the design capability to “sink” the engine deeper into the frame rails. This may occur as the oil pan has a thinner dimension, the clearance to the suspension is increased, and the engine height therefore can be shortened. As a result, the truck hood shape could be changed to allow for space efficiency and for a more aerodynamic design.

In operation, the service procedure would be to disconnect the inlet and outlet from supply lines of the engine lubrication filtration system. The assembly is removed, and replace with a new sump and filter assembly (or service package). In this regard, service time and complexity go down dramatically, and cleanliness of service is improved.

A brief list of some of the benefits enjoyed by the unique sump component and filter component combinations is provided below:
1. Service time is greatly reduced
2. Tools needed to do the job may be reduced
3. The service environment is much better (cleaner, free of oil spills)
4. Opportunity for engine height reduction can allow OEMs flexibility in hood design for added aerodynamic features increasing efficiency (engines without this technology would have difficulty providing the same benefit in space reduction to the OEMs).

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A sump and filter assembly for an engine, comprising:
a sump component including a capacity for fluid; and
a filter component operatively connected with the sump component, the filter component configured to filter fluid from the sump component;
the sump component and the filter component defining an inlet, an outlet, and a fluid pathway between the inlet and outlet, the inlet disposed at the sump component and receivable of fluid, the outlet disposed at the filter component and enabling release of fluid, and the fluid pathway enabling fluid entering the inlet to flow from the sump component, to the filter component and through the filter component to the outlet,
wherein the sump component comprising a plurality of sumps, each sump including at least one said filter component disposed inside each sump, an inlet disposed at each sump, and an outlet disposed at each filter component.

2. (canceled)

3. The sump and filter assembly according to claim 1, wherein the filter component comprising a plurality of filter elements inside the sump component, each filter element including an outlet.

4. The sump and filter assembly according to claim 1, wherein at least one sump of the sump component is a container enabling fluid flow therethrough to the corresponding filter component.

5. The sump and filter assembly according to claim 1, wherein at least one sump of the sump component is a container that may be closed to enable storage of fluid, when the assembly is not ready for use.

6. The sump and filter assembly according to claim 1, wherein at least one sump of the sump component is a bucket including the corresponding filter component therein.

7. The sump and filter assembly according to claim 1, wherein each of the sumps of the sump component is a bag in a bucket, which includes the corresponding filter component therein.

8. The sump and filter assembly according to claim 1, wherein the filter component is mounted inside the corresponding sump of the sump component.

9. The sump and filter assembly according to claim 1, further comprising cooling fins disposed on an outer surface of at least one sump of the sump component.

10. A lubrication filter assembly for a vehicle engine, comprising:
a sump component including a capacity for lubrication oil; and
a filter component operatively connected with the sump component, the filter component configured to filter lubrication oil from the sump component;
the sump component and the filter component defining an inlet, an outlet, and a lubrication oil pathway between the inlet and outlet, the inlet disposed at the sump component being configured to receive lubrication oil, the outlet disposed at the filter component and enabling release of lubrication oil, and the fluid pathway enabling lubrication oil entering the inlet to flow from the sump component, to the filter component, and through the filter component to the outlet.
wherein the sump component comprises a plurality of sumps, each sump including at least one filter component disposed inside each sump, an inlet disposed at each sump, and an outlet disposed at each filter component.

11. The lubrication filter assembly of claim 10, wherein the sump component and the filter component are configured to be remotely disposed from an engine of the vehicle.

12. The lubrication filter assembly according to claim 10, wherein the sump component and the filter component are configured to be disposed on an engine lubrication system pathway of the vehicle, the sump component and the filter component being configured to be disposed between a lubrication oil pump and an engine of the vehicle on the engine lubrication system pathway.

13. (canceled)

14. The lubrication filter assembly according to claim 10, wherein the filter component further comprises a plurality of filter elements inside at least one sump of said sump component, each filter element provided includes an outlet.

15. The lubrication filter assembly according to claim 10, wherein at least one sump of the sump component is a bucket including the corresponding filter component therein.

16. The lubrication filter assembly according to claim 10, wherein each of the sumps of the sump component is a bag in a bucket, which includes the corresponding filter component therein.

17. The lubrication filter assembly according to claim 10, further comprising cooling fins disposed on at least one sump of the sump component.

18-20. (canceled)

21. A sump and filter assembly for an engine, comprising:
a sump component including a capacity for fluid; and
a filter component operatively connected with the sump component, the filter component configured to filter fluid from the sump component;
the sump component and the filter component defining an inlet, an outlet, and a fluid pathway between the inlet and outlet, the inlet disposed at the sump component and receivable of fluid, the outlet disposed at the filter component and enabling release of fluid, and the fluid pathway enabling fluid entering the inlet to flow from the sump component, to the filter component, and through the filter component to the outlet, wherein the filter component comprising a plurality of filter elements inside the sump component, each filter element including an outlet.
